(19) United States
(12) Patent Application Publication
(10) Pub. No.: US 2010/0091487 A1
(43) Pub. Date: Apr. 15, 2010

(54) HEAT DISSIPATION MEMBER HAVING VARIABLE HEAT DISSIPATION PATHS AND LED LIGHTING FLOOD LAMP USING THE SAME

(75) Inventor: Sung Ho Shin, Gwangmyeong-si (KR)

Correspondence Address: SEED INTELLECTUAL PROPERTY LAW GROUP PLLC, 701 FIFTH AVE, SUITE 5400, SEATTLE, WA, 98104, US

(73) Assignee: HYUNDAI TELECOMMUNICATION CO., LTD., Seoul (KR)

(21) Appl. No.: 12/371,521

(22) Filed: Feb. 13, 2009

(30) Foreign Application Priority Data
Oct. 13, 2008 (KR) 10-2008-0100393

(51) Int. Cl. F21V 29/00; F21S 4/00; F21V 1/00

(52) U.S. Cl. 362/235; 362/373; 362/249.02

(57) ABSTRACT

A heat dissipation member having variable heat dissipation paths and an LED lighting flood lamp using the same are provided, which can maximize heat dissipation effect by widening an air contact area and making air flow rapidly, seek a waterproof effect and prevention of a scald due to contact with a high-temperature heat dissipation plate, and prevent the reduction of heat dissipation efficiency caused by foreign substances by keeping wings of the heat dissipation plate not exposed to an outside. The LED lighting flood lamp using a heat dissipation member having variable heat dissipation paths includes LEDs, an LED mounting substrate on which the LEDs are mounted, a heat dissipation member having a lower part to which the LED mounting substrate is fixed and provided with the variable heat dissipation paths formed thereon, an upper cap fixed to outer surfaces of heat dissipation plates of the heat dissipation member; a fixing ring member fixed to the lower part of the heat dissipation member to achieve inflow of outside air, and a lower lens fixed to a lower part of the cap.

### CROSS-REFERENCE TO RELATED APPLICATION

This application is based on and claims priority from Korean Patent Application No. 10-2008-100393, filed on Oct. 13, 2008 in the Korean Intellectual Property Office, the disclosure of which is incorporated herein in its entirety by reference.

### BACKGROUND OF THE INVENTION

1. Field of the invention

The present invention relates to a heat dissipation member having variable heat dissipation paths and an LED lighting flood lamp using the same, and more particularly, to a heat dissipation member having variable heat dissipation paths and an LED lighting flood lamp using the same, which can maximize heat dissipation effect by widening an air contact area and making air flow rapidly through variation of the size of the heat dissipation paths formed on the heat dissipation member, seek a waterproof effect through the use of O-rings and prevention of a scald due to contact with a high-temperature heat dissipation plate, and prevent the reduction of heat dissipation efficiency caused by foreign substances by keeping wings of the heat dissipation plate not exposed to an outside.

2. Description of the Prior Art

In general, various kinds of flood lamps including vehicle head lamps, rear combination lamps, street lamps, and the like, use a bulb as their light source.

However, since the conventional bulb has a short life span and a lowered anti-shock performance, there is a recent trend that a high-luminance LED (Light Emitting Diode) having a long life span and an excellent anti-shock performance is used as a light source.

Particularly, the high-luminance LED can be used as a light source of various kinds of flood lamps including vehicle head lamps, rear combination lamps, interior lamps, street lamps, and the like, and its application range is extensive.

The high-luminance LED emits superheat when it is turned on, and due to this superheat emission, there are difficulties in designing and applying the LED as a light source.

FIGS. 1A to 1C are views illustrating examples of one conventional LED lighting flood lamp, and FIGS. 2A and 2B are views illustrating examples of another conventional. LED lighting flood lamp.

As illustrated in the drawings, the heat dissipation plates are formed in order at predetermined intervals. FIGS. 1A to 1C show curved heat dissipation plates 11 and 21, and FIGS. 2A and 2B show straight heat dissipation plates 31.

In the case of the conventional LED lighting flood lamp 10 or 30 as described above, a lens part 13 or 33 is fixed to the front part of the main body of the lamp on which a heat dissipation plate 11, 21, or 31 is formed.

The conventional heat dissipation plate 11, 21, or 31 is a wing type heat dissipation plate having wings formed at predetermined intervals to be in contact with outside air, and by widening the surface area of the heat dissipation plate 11, 21, and 31 that is in contact with outside air, the heat dissipation effect can be maximized.

However, according to the conventional LED lighting flood lamp 10, the heat dissipation plate 11, 21, or 31 is exposed to an outside, and thus foreign substances such as dust are accumulated on the heat dissipation plate 11, 21, or 31 and wings of the heat dissipation plate, while the heat dissipation plate is exposed indoors or outdoors, to deteriorate the heat dissipation efficiency of the heat dissipation plate. This exerts a bad effect on the lifespan or illumination of the LED lighting flood lamp vulnerable to heat to deteriorate the characteristic of LED having a semi-permanent lifespan. In addition, in the case where the heat dissipation plate is exposed to an outside, there are limitations in the design of the LED lighting flood lamp, and a waterproof effect cannot be sought.

### SUMMARY OF THE INVENTION

Accordingly, the present invention has been made to solve the above-mentioned problems occurring in the prior art while advantages achieved by the prior art are maintained intact.

One object of the present invention is to provide a heat dissipation member having variable heat dissipation paths and an LED lighting flood lamp using the same, which have excellent heat dissipation effects and waterproof and dustproof functions.

In order to accomplish this object, there is provided a heat dissipation member having variable heat dissipation paths, according to an embodiment of the present invention, which includes a cylindrical main body in which a through-hole is formed; and a plurality of heat dissipation plates formed along the circumference of the main body in a length direction of the main body; wherein the heat dissipation plates include curved heat dissipation plates arranged with curves in the length direction of the main body, and a gap between two opposite curved heat dissipation plates in the length direction of the main body is widened or narrowed to vary the size of the heat dissipation paths.

The heat dissipation path may become widest in a lower part of the heat dissipation member, and may be narrowed as it goes to its upper part.

In another aspect of the present invention, there is provided an LED lighting flood lamp using a heat dissipation member having variable heat dissipation paths, which includes LEDs; an LED mounting substrate on which the LEDs are mounted; a heat dissipation member having a lower part to which the LED mounting substrate is fixed, and provided with heat dissipation paths formed on its circumference in a length direction of the lamp; an upper cap fixed to outer surfaces of heat dissipation plates of the heat dissipation member, and having penetration grooves formed thereon to be communicated with the heat dissipation paths; a fixing ring member fixed to the lower part of the heat dissipation member, and having penetration grooves formed on the circumference thereof to be communicated with the heat dissipation paths; and a lower lens fixed to a lower part of the fixing ring member.

O-rings may be installed between an upper fixing part and a lower fixing part of the heat dissipation member to improve sealing performance.

The fixing ring member may have the penetration grooves formed on the circumference thereof to pass outside air therethrough so that the outside air flows through a space formed between the heat dissipation plates of the heat dissipation member.

In still another aspect of the present invention, there is provided an LED lighting flood lamp using a heat dissipation member having variable heat dissipation paths, which includes LEDs; an LED mounting substrate on which the LEDs are mounted; a heat dissipation member having a lower part to which the LED mounting substrate is fixed, and provided with the variable heat dissipation paths formed thereon; an upper cap fixed to outer surfaces of heat dissipation plates of the heat dissipation member; and a lower lens fixed to a lower part of the cap.

Lower part penetration grooves may be formed around a lower part of the upper cap to be communicated with penetration grooves formed on an upper side of the upper cap through inside heat dissipation paths.

The penetration grooves formed around the lower part of the upper cap may be formed to be inclined.

In still another aspect of the present invention, there is provided a heat dissipation member having variable heat dissipation paths, which includes heat dissipation paths formed at predetermined intervals on the inside of an edge part of a cylindrical main body along the circumference of the main body; wherein the heat dissipation paths include straight heat dissipation paths arranged in a straight line in an axis direction of the cylindrical main body and cylindrical heat dissipation paths the size of which is varied in a length direction of the cylindrical main body.

The cylindrical heat dissipation path may become narrower as it reaches the center thereof in which Bernoulli's principle is applied.

In still another aspect of the present invention, there is provided an LED lighting flood lamp using a heat dissipation member having variable heat dissipation paths, which includes LEDs; an LED mounting substrate on which the LEDs are mounted; a heat dissipation member having a lower part to which the LED mounting substrate is fixed, and provided with heat dissipation paths formed at predetermined intervals on the inside of an edge part of a cylindrical main body along the circumference of the main body, the heat dissipation paths including cylindrical heat dissipation paths the size of which is varied in a length direction of the cylindrical main body; an upper cap fixed to the upper side of the heat dissipation member; a fixing ring member fixed to the lower part of the heat dissipation member to achieve inflow of outside air; and a lower lens fixed to a lower part of the fixing ring member.

According to the LED lighting flood lamp using a heat dissipation member having variable heat dissipation paths according to the present invention, since heat dissipation plates are covered by an upper cap so that the heat dissipation plates are not exposed to an outside, the dustproof and waterproof effects and prevention of a scald due to contact with high-temperature heat dissipation plates can be sought.

Also, by changing the heat dissipation paths formed by the arrangement of heat dissipation plates, in which Bernoulli's principle is applied, the surface area of the heat dissipation plates is widened with the air flow rate increased, and thus the heat dissipation effect can be improved.

In addition, since the heat dissipation plates are not exposed to an outside, the degree of freedom of design is heightened, and more effective waterproof function is exhibited through the use of O-rings on the upper and lower fixing parts of the heat dissipation member.

### BRIEF DESCRIPTION OF THE DRAWINGS

The above and other objects, features and advantages of the present invention will be more apparent from the following detailed description taken in conjunction with the accompanying drawings, in which:

FIGS. 1A to 1C are views illustrating examples of one conventional LED lighting flood lamp;

FIGS. 2A and 2B are views illustrating examples of another conventional LED lighting flood lamp;

FIGS. 3A to 3C are views illustrating an LED lighting flood lamp using a heat dissipation member having variable heat dissipation paths according to the first embodiment of the present invention;

FIGS. 4A to 4D are views illustrating the structure of a heat dissipation member of an LED lighting flood lamp according to the first embodiment of the present invention;

FIG. 5 is a sectional view illustrating the structure of an LED lighting flood lamp using a heat dissipation member having variable heat dissipation paths according to the second embodiment of the present invention;

FIGS. 6A to 6C are views illustrating an LED lighting flood lamp using a heat dissipation member having variable heat dissipation paths according to the third embodiment of the present invention; and

FIGS. 7A to 7D are views illustrating the structure of a heat dissipation member of an LED lighting flood lamp according to the third embodiment of the present invention.

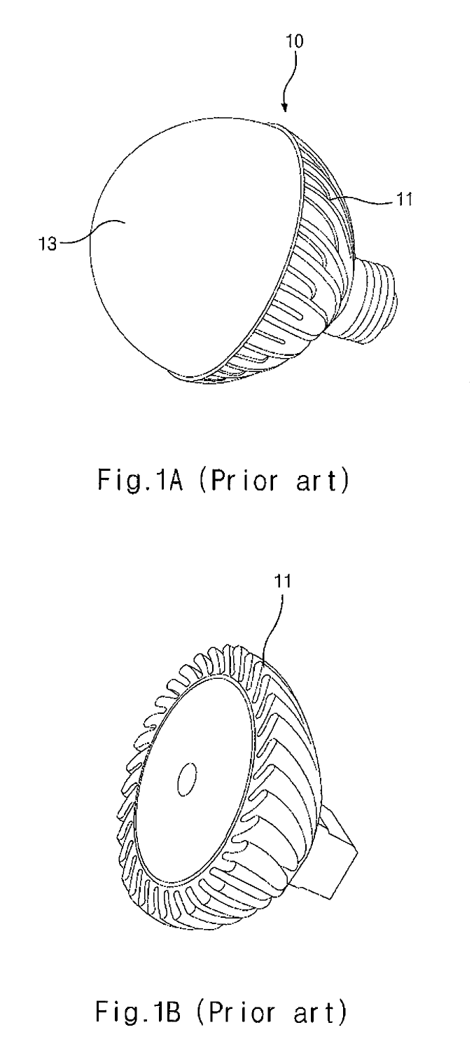

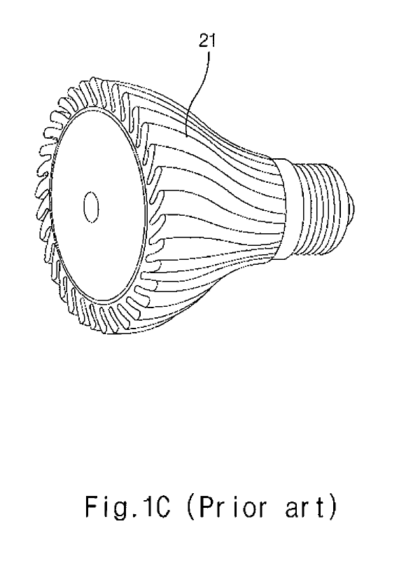

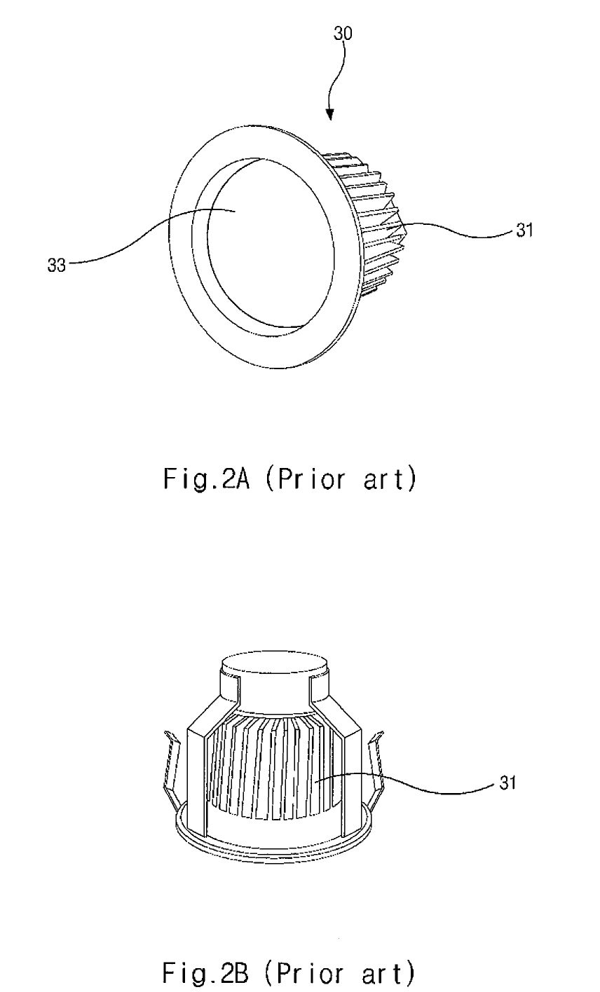

### DETAILED DESCRIPTION OF THE PREFERRED EMBODIMENTS

Hereinafter, an LED lighting flood lamp according to the preferred embodiments of the present invention will be described in detail with reference to the accompanying drawings.

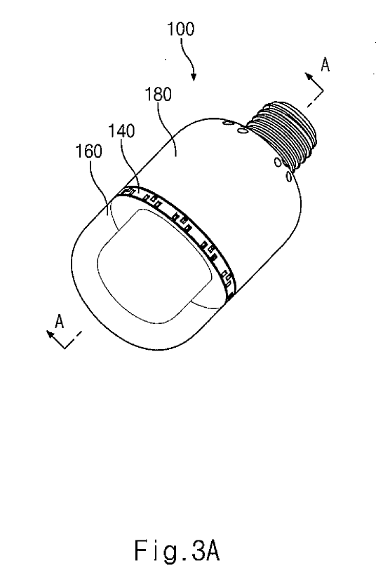

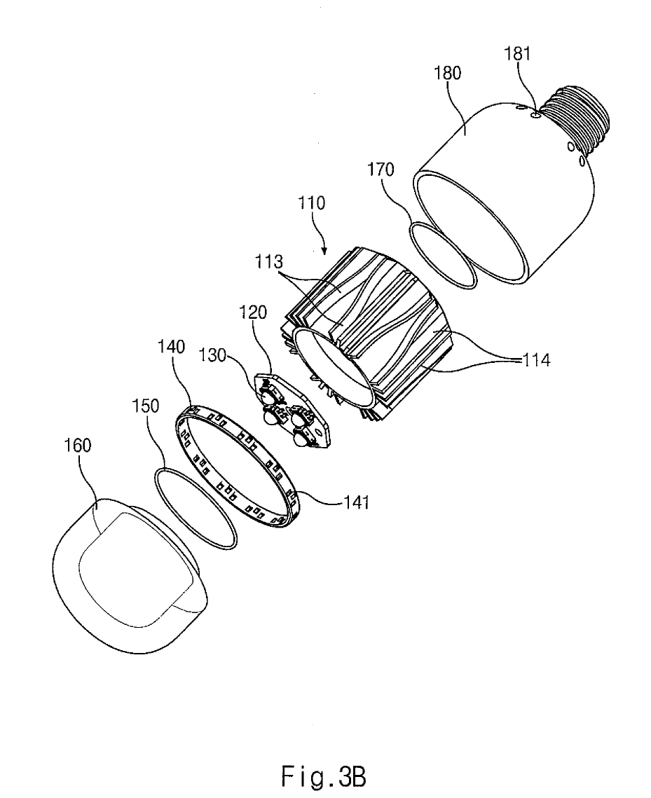

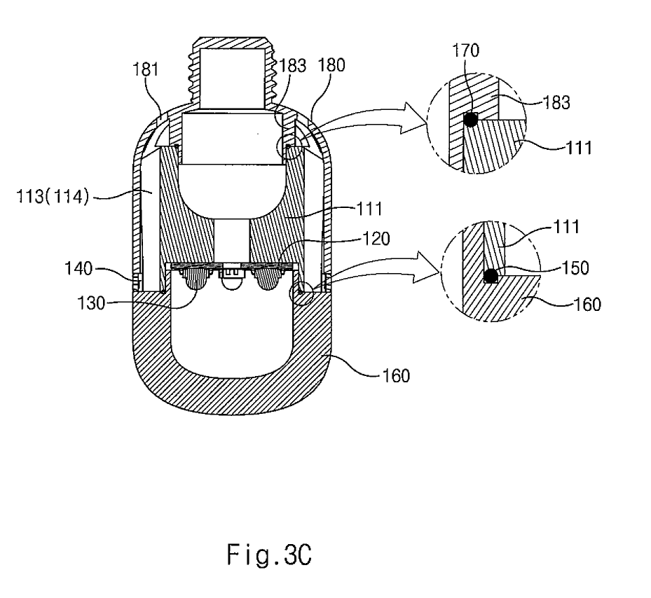

FIGS. 3A to 3C are views illustrating an LED lighting flood lamp according to the first embodiment of the present invention. FIG. 3A is a perspective view of the LED lighting flood lamp according to the first embodiment of the present invention, FIG. 3B is an exploded perspective view of the LED lighting flood lamp illustrated in FIG. 3A, and FIG. 3C is a sectional view taken along line A-A in FIG. 3A.

As illustrated, the LED lighting flood lamp 100 according to the first embodiment of the present invention includes a plurality of LEDs 130; an LED mounting substrate 120 on which the LEDs 130 are mounted; a heat dissipation member 110 having a lower part to which the LED mounting substrate 120 is fixed, and provided with heat dissipation plates 113 and 114 formed on its circumference; an upper cap 180 fixed to outer surface of the heat dissipation member 110; a fixing ring member 140 fixed to the lower part of the heat dissipation member 110 to achieve inflow of outside air; and a lower lens 160 fixed to a lower part of the fixing ring member 140.

O-rings 150 and 170 are installed between an upper fixing part and a lower fixing part of the heat dissipation member 110 to improve the sealing performance. For example, the O-ring 170 is inserted between the fixing parts of the heat dissipation member 110 and the upper cap 180, and the O-ring 150 is inserted between the fixing parts of the heat dissipation member 110 and the lower lens 160.

In the heat dissipation structure of the LED lighting flood lamp 100 as constructed above according to the present invention, a plurality of heat dissipation plates 113 and 114 is formed along the circumference of the heat dissipation member 110.

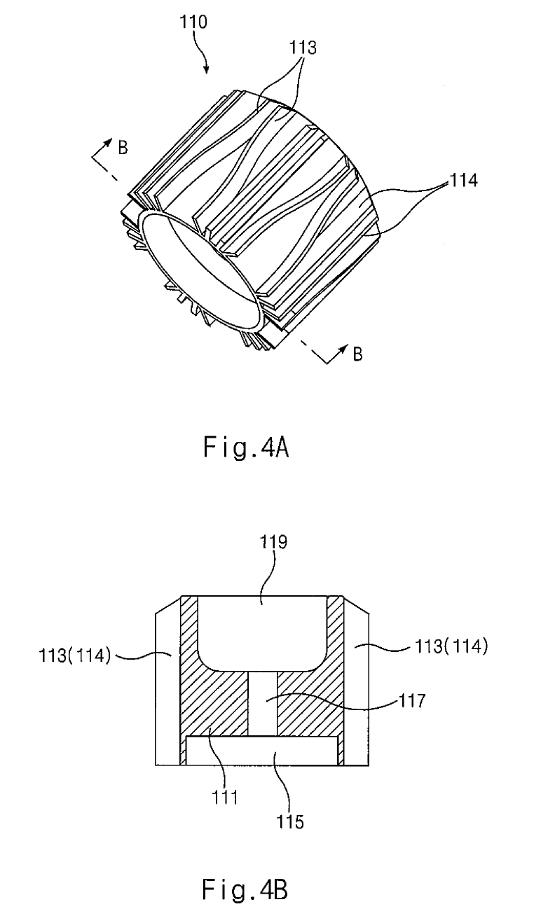

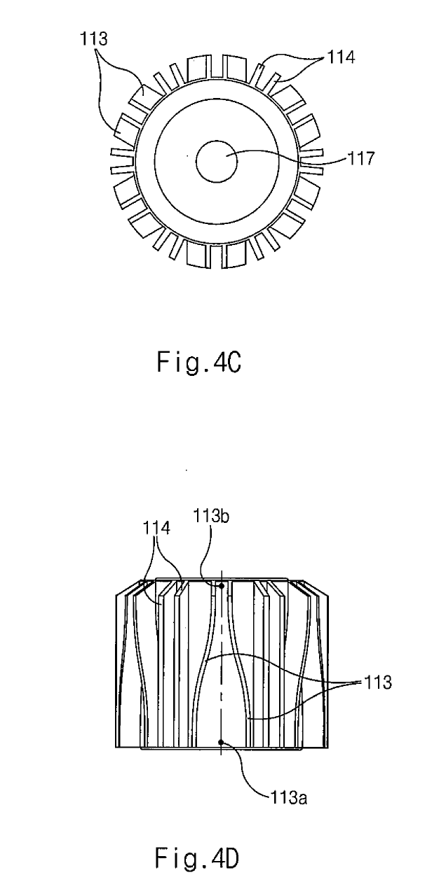

FIGS. 4A to 4D are views illustrating the structure of the heat dissipation member 110 of the LED lighting flood lamp 100 according to the first embodiment of the present invention. FIG. 4A is a perspective view of the heat dissipation member 110, FIG. 4B is a sectional view taken along line B-B in FIG. 4A, FIG. 4C is a front view of the heat dissipation member 110 in FIG. 4A, and FIG. 4D is a plan view of the heat dissipation member 110 in FIG. 4A.

With reference to the accompanying drawings, the heat dissipation member 110 having variable heat dissipation paths includes a cylindrical main body 111 in which a through-hole 117 is formed; and a plurality of heat dissipation plates 113 and 114 formed along the circumference of the main body 111 in a length direction of the main body 111. The first space part 115 is formed in the lower part of the main body 111 of the heat dissipation member, and the second space part 119 is formed in the upper part of the main body. In this case, it is preferable that the second space part 119 has a size larger than the first space part 115. An LED substrate 120 is inserted onto the first space part 115 of the main body 111.

The heat dissipation plates 113 and 114 are formed at predetermined intervals along the outer circumference of the main body 111 of the heat dissipation member, and include straight heat dissipation plates 114 and curved heat dissipation plates 113 which project upward at a predetermined height.

Particularly, as illustrated in FIGS. 4A to 4D, the curved heat dissipation plates 113 are curved in a length direction (i.e. axis direction) of the main body 111 of the heat dissipation member, and a gap between two opposite curved heat dissipation plates is varied in accordance with the curved state of the curved heat dissipation plates 113. For example, in the case of the curved heat dissipation plates 113 as illustrated in the drawings, the gap between the curved heat dissipation plates 113 becomes maximized in the lower part 113a of the heat dissipation member 110, and becomes minimized in the upper part 113b of the heat dissipation member 110. In this case, the air rate flowing along the curved heat dissipation plates 113 is low in the wide lower part 113a, but the air rate flowing along the curved heat dissipation plates 113 is high in the upper part 113b since the gap becomes narrower as it goes to the upper part 113b.

In the embodiment of the present invention, both the curved heat dissipation plates 113 and the straight heat dissipation plates 114 coexist. The two kinds of heat dissipation plates 113 and 114 are repeatedly formed in twos along the outer circumference of the heat dissipation member 110. For example, after two opposite curved heat dissipation plates 113 are formed, two straight heat dissipation plates 114 are formed to neighbor the curved heat dissipation plates 113, and then two curved heat dissipation plates 113 and two straight heat dissipation plates 114 are alternately arranged along the circumference of the heat dissipation member 110.

As described above, both the straight heat dissipation plates 114 and the curved heat dissipation plates may be alternately formed as in the embodiment of the present invention, or only the straight heat dissipation plates 114 or the curved heat dissipation plate 113 may be independently formed on the outside of the heat dissipation member 110.

The space formed on the inside of the curved heat dissipation plates 113 is in the form of a Venturi tube, and wide space and narrow space are formed in the length direction of the heat dissipation member 110 to vary the size of the heat dissipation paths in the length direction of the heat dissipation member.

Accordingly, fluid passing through a portion such as the Venturi tube becomes fast to accelerate the heat dissipation. Also, in forming the curved heat dissipation plates 113 according to the present invention, the whole surface area of the heat dissipation plates is increased to cause the air contact area of the curved heat dissipation plates 113 to be increased, and thus the heat dissipation effect can be heightened.

Also, according to the present invention, since the upper cap 180 is mounted on the outer circumference of the heat dissipation member 110 and the heat generated from the heat dissipation member 110 is intercepted by the upper cap 180, a user is prevented from being scalded due to the contact with the heat dissipation member.

Also, since the upper cap 180 is engaged with the heat dissipation member 110 by force fitting, and seals the interior thereof by covering the upper end part of the exposed heat dissipation plates 113 and 114, heat dissipation paths are formed to provide interior paths through which air flows.

In addition, since the heat dissipation member 110 is prevented from being exposed to an outside due to the mount of the upper cap 180, foreign substances such as dust is prevented from sticking to the heat dissipation plates 113 and 114, and thus the reduction of the heat dissipation efficiency due to the sticking foreign substances can be prevented.

In addition, since the upper cap 180 is positioned on the outside of the inner heat dissipation plates 113 and 114 and discharges heat transferred form the inner heat dissipation plates to an outside, it serves as a heat dissipation plate as well to correspond to the use of two heat dissipation plates.

The upper cap 180 has a plurality of grooves 181 formed on the upper side thereof and a fixing protrusion part 183 formed on the inside thereof to be fixed to the heat dissipation member 110. The grooves 181 serve as paths communicated with heat dissipation paths to discharge the inflow air to an outside.

In addition, O-rings 150 and 170 are doubly inserted into the upper and lower fixing parts of the heat dissipation member 110 to intercept water flowing into the heat dissipation member 110. That is, the insertion of the O-rings 150 and 170 separates the circuit part and the heat dissipation part from each other.

The fixing ring member 140 mounted between the upper cap 180 and the lower lens 160 has a plurality of penetration grooves 141 formed thereon to achieve inflow of outside air therethrough. The fixing ring member 140 is fixed to an outside of the heat dissipation member 110 according to the present invention. If the outside air flows through the penetration grooves 141, it flows through the heat dissipation plates 113 and 114 and a space formed between the heat dissipation plates 113 and 114, and then is finally discharged to an outside through the penetration groove 181 formed on the upper side of the upper cap 180.

Accordingly, even in an assembled state of the LED lighting flood lamp 100 according to the present invention, inflow of an outside air is performed, and the inflow air flows fast through the space between the heat dissipation plates 113 and 114 to achieve prompt heat dissipation.

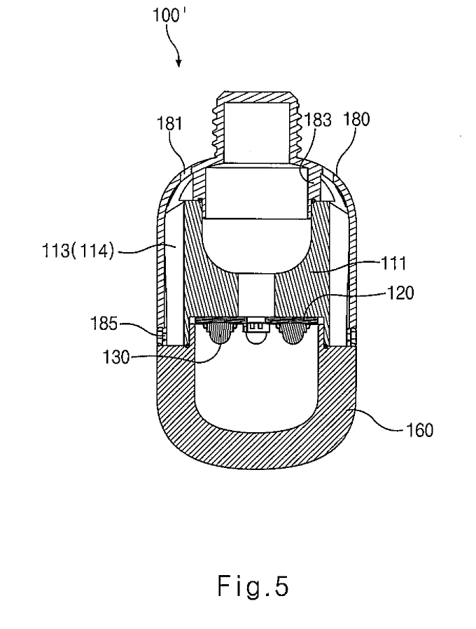

On the other hand, FIG. 5 is a sectional view illustrating the structure of an LED lighting flood lamp using a heat dissipation member having variable heat dissipation paths according to the second embodiment of the present invention.

The LED lighting flood lamp 100′ according to the second embodiment of the present invention may be provided by deleting the fixing ring member 140 from the LED lighting flood lamp according to the first embodiment of the present invention as described above. The lower end part of the upper cap 180 is further extended and penetration grooves 185 are formed on the circumference thereof so as to serve as the deleted fixing ring member 140.

In this case, the penetration grooves 185 are inclined grooves that can make the outside air smoothly flow to the heat dissipation paths.

In this embodiment of the present invention, the number of assembled components constituting the LED lighting flood lamp can be reduced, and the process and fixing work can be easily performed.

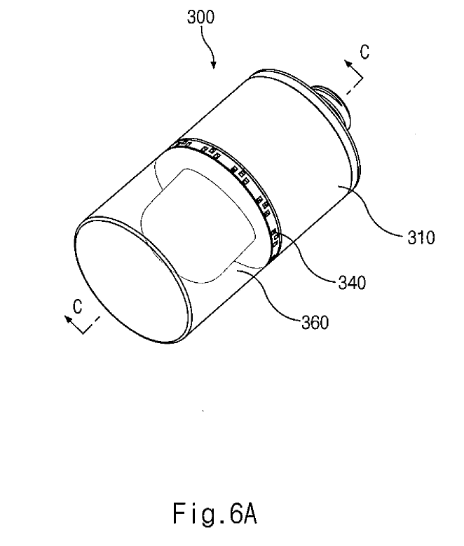

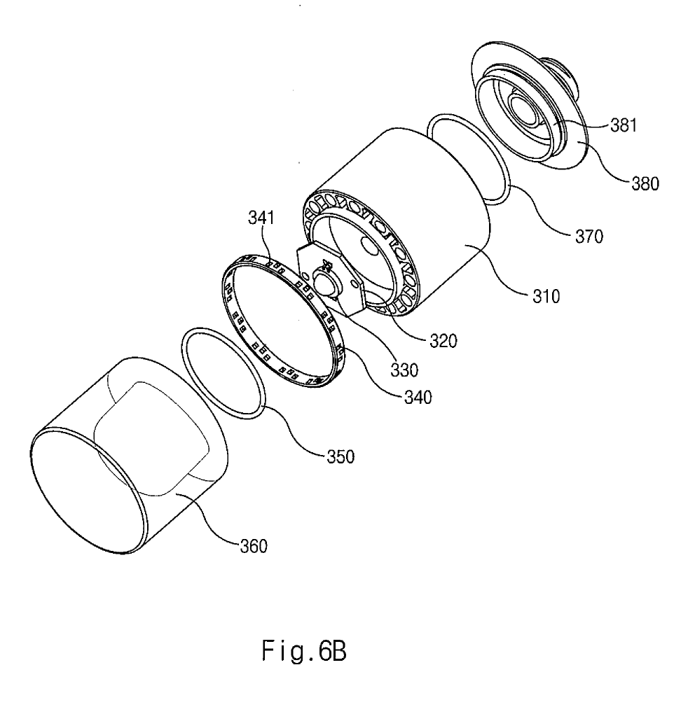

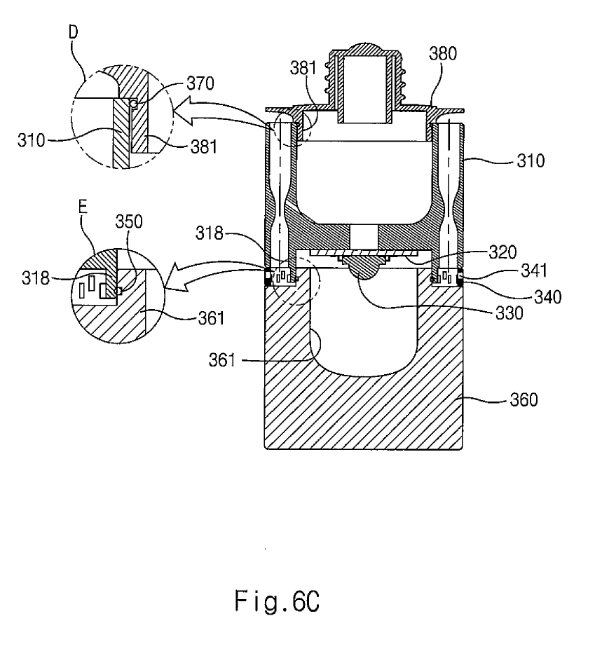

FIGS. 6A to 6C are views illustrating an LED lighting flood lamp 300 using a heat dissipation member having variable heat dissipation paths according to the third embodiment of the present invention. FIG. 6A is a perspective view of the LED lighting flood lamp, FIG. 6B is an exploded perspective view of the Led lighting flood lamp in FIG. 6A, and FIG. 6C is a sectional view taken along line C-C in FIG. 6A.

The LED lighting flood lamp 300 using a heat dissipation member having variable heat dissipation paths according to the third embodiment of the present invention includes LEDs 330; an LED mounting substrate 320 on which the LEDs 330 are mounted; a heat dissipation member 310 having a lower part to which the LED mounting substrate 320 is fixed, and having heat dissipation spaces 313 formed at predetermined intervals on the circumference of a cylindrical main body; an upper cap 380 fixed to the upper side of the heat dissipation member 310; a fixing ring member 340 fixed to the lower part of the heat dissipation member 310 to achieve inflow of outside air; and a lower lens 360 fixed to the lower part of the fixing ring member 340.

O-rings 350 and 370 are installed in an upper part and a lower part of the heat dissipation member 310. For example, the upper O-ring 370 is inserted between the fixing parts of the upper part of the heat dissipation member 310 and a lower projection end 381 of the upper cap 380 (See “D” part in FIG. 6C), and the lower O-ring 350 is inserted between the fixing parts of the lower projection part 318 of the heat dissipation member 310 and an upper projection part 361 of the lower lens 360 (See “E” part in FIG. 6C).

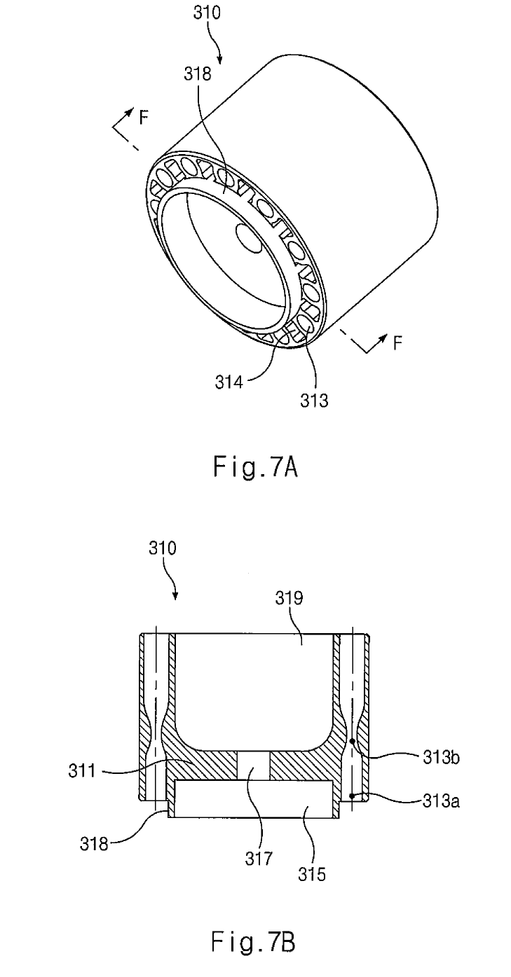

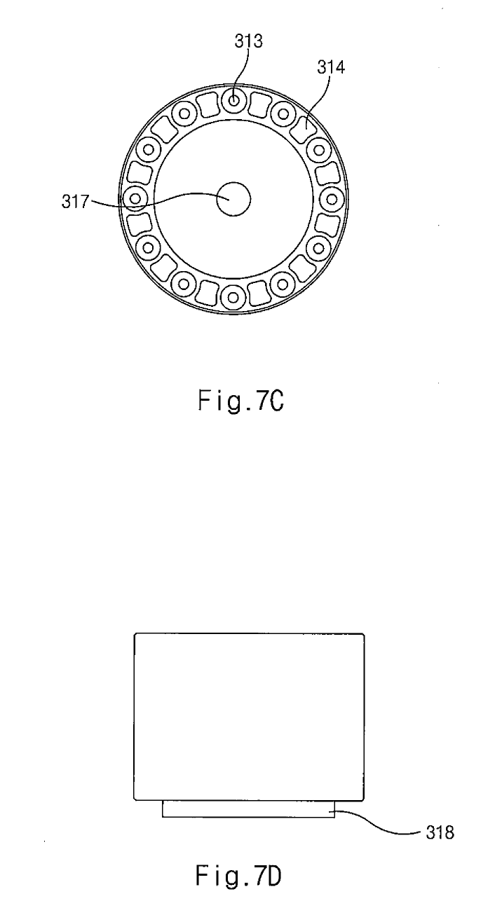

In the structure of the LED lighting flood lamp 300 according to the third embodiment of the present invention, heat dissipation paths 313 and 314 are formed on the inside of an edge part along the circumference of the heat dissipation member 310. This structure is illustrated in FIGS. 7A to 7D.

FIG. 7A is a perspective view of a heat dissipation member 310 having variable heat dissipation paths according to the third embodiment of the present invention, FIG. 7B is a sectional view taken along line F-F in FIG. 7A, FIG. 7C is a front view of the heat dissipation member 310 in FIG. 7A, and FIG. 7D is a plan view of the heat dissipation member 310.

With reference to the accompanying drawings, a through-hole 317 is formed in the center part of the inside of the heat dissipation member 310 having variable heat dissipation paths, and heat dissipation paths 313 and 314 are formed at predetermined intervals along the outer circumference of the heat dissipation member 310.

In the lower part of the heat dissipation member 310, the first space part 315 is formed, and in the upper part thereof, the second space part 319 that is larger than the first space part 315 is formed. In the inside of the first space part 315, an LED mounting substrate 320 is inserted.

In the center part of the heat dissipation member 310, the projection part 318 is formed to extend downward for a specified distance, and in the inside of the projection part 318, the first space part 315 is formed.

On the outside of the projection part 318 in the center of the heat dissipation member 310, the fixing ring member 340 is placed. In a state that the fixing ring member 340 is fixed, outside air flowing through penetration grooves 341 formed on the circumference of the fixing ring member flows to the heat dissipation paths 313 and 314 formed on the heat dissipation member 310.

As illustrated in FIGS. 7B and 7C, the heat dissipation paths 313 and 314 includes straight heat dissipation paths 314 and cylindrical heat dissipation path 313 neighboring the straight heat dissipation paths, which are alternately arranged in a circle along the shape of the heat dissipation member 310.

As illustrated in FIG. 7B, the cylindrical heat dissipation paths 313 are formed in a length direction (i.e. axis direction) of the heat dissipation member 310. In the center part of the cylindrical heat dissipation path 313, a projection end is formed to narrow the space in the heat dissipation path, and in other parts thereof, the space having the original size is formed. Accordingly, the lower or upper part of the cylindrical heat dissipation path 313 is wider than the center part thereof.

Accordingly, the air flow through the cylindrical heat dissipation path 313 becomes slow in the wide lower part 313a thereof, but becomes fast in the narrow center part 313b thereof. Accordingly, the air flow through the cylindrical heat dissipation path 313 becomes faster in the center part of the heat dissipation path to achieve prompt heat dissipation.

On the other hand, in the case of the straight heat dissipation path 314, the sectional area of the inside of the heat dissipation path is not changed, and thus the air flow is performed at uniform speed.

As described above, according to the LED lighting flood lamp according to the present invention, the heat dissipation effect is maximized by widening an air contact area and making air flow rapidly through variation of the size of the heat dissipation paths formed on the heat dissipation member. Also, since the heat dissipation plates are covered by an upper cap so that the heat dissipation plates are not exposed to an outside, the dustproof effect and prevention of a scald due to contact with high-temperature heat dissipation plates can be sought.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A heat dissipation member comprising:
a cylindrical main body in which a through-hole is formed; and
a plurality of heat dissipation plates formed along the circumference of the main body in a length direction of the main body;
wherein the heat dissipation plates include curved heat dissipation plates arranged with curves in the length direction of the main body, and a gap between two opposite heat dissipation plates in the length direction of the main body is widened or narrowed to vary the size of a heat dissipation paths.

2. The heat dissipation member of claim 1, wherein the heat dissipation path becomes widest in a lower part of the heat dissipation member, and is narrowed as it goes to its upper part.

3. An LED lighting flood lamp comprising:
LEDs;
an LED mounting substrate on which the LEDs are mounted;
a heat dissipation member having a lower part to which the LED mounting substrate is fixed, and provided with heat dissipation paths formed on its circumference in a length direction of the lamp;
an upper cap fixed to outer surfaces of heat dissipation plates of the heat dissipation member, and having penetration grooves formed thereon to be communicated with the heat dissipation paths;
a fixing ring member fixed to the lower part of the heat dissipation member, and having penetration grooves formed thereon to be communicated with the heat dissipation paths to achieve inflow of outside air; and
a lower lens fixed to a lower part of the fixing ring member.

4. The LED lighting flood lamp of claim 3, wherein the heat dissipation member is the heat dissipation member as recited in claim 1.

5. The LED lighting flood lamp of claim 3, wherein O-rings are installed on an upper fixing part and a lower fixing part of the heat dissipation member to improve sealing performance.

6. An LED lighting flood lamp comprising:
LEDs;
an LED mounting substrate on which the LEDs are mounted;
a heat dissipation member having a lower part to which the LED mounting substrate is fixed, and provided with heat dissipation paths formed on its circumference in a length direction of the lamp;
an upper cap fixed to outer surfaces of heat dissipation plates of the heat dissipation member; and
a lower lens fixed to a lower part of the upper cap.

7. The LED lighting flood lamp of claim 6, wherein penetration grooves are formed around a lower part of the upper cap to be communicated with penetration grooves formed on an upper side of the upper cap through heat dissipation paths.

8. The LED lighting flood lamp of claim 6, wherein the heat dissipation member is the heat dissipation member as recited in claim 1.

9. A heat dissipation member comprising:
heat dissipation paths formed at predetermined intervals on the inside of an edge part of a cylindrical main body along the circumference of the main body;
wherein the heat dissipation paths include cylindrical heat dissipation paths the size of which is varied in a length direction of the cylindrical main body.

10. The heat dissipation member of claim 9, wherein the cylindrical heat dissipation path becomes narrower as it reaches the center thereof in which Bernoulli's principle is applied.

11. The heat dissipation member of claim 9, wherein the heat dissipation paths further include straight heat dissipation paths alternately arranged in neighboring parts of the cylindrical heat dissipation paths

12. The heat dissipation member of claim 9, wherein a projection part extending downward for a specified length is formed in a center region of the heat dissipation member, and on the outside of the projection part, the fixing ring member is placed.

13. An LED lighting flood lamp comprising:
LEDs;
an LED mounting substrate on which the LEDs are mounted;
a heat dissipation member having a lower part to which the LED mounting substrate is fixed, and provided with heat dissipation paths formed at predetermined intervals on the inside of an edge part of a cylindrical main body along the circumference of the main body, the heat dissipation paths including cylindrical heat dissipation paths the size of which is varied in a length direction of the cylindrical main body;
an upper cap fixed to the upper side of the heat dissipation member;
a fixing ring member fixed to the lower part of the heat dissipation member to achieve inflow of outside air; and
a lower lens fixed to a lower part of the fixing ring member.

14. The LED lighting flood lamp of claim 13, wherein O-rings are installed on an upper fixing part and a lower fixing part of the heat dissipation member to improve sealing performance.
